(19) United States
(12) Patent Application Publication
(10) Pub. No.: US 2016/0114267 A1
(43) Pub. Date: Apr. 28, 2016

(54) CROSS-FLOW SHAKER AND METHOD FOR USING THE SAME

(71) Applicant: M-I L.L.C., Houston, TX (US)

(72) Inventors: Eric Cady, Walton, KY (US); Bradley Jones, Crestview Hills, KY (US)

(21) Appl. No.: 14/889,953

(22) PCT Filed: May 15, 2014
(86) PCT No.: PCT/US2014/038023

§ 371 Date: Nov. 9, 2015

Related U.S. Application Data
(60) Provisional application No. 61/823,619, filed on May 15, 2013.

(51) Int. Cl. B01D 33/03; B01D 33/72; E21B 21/06

(52) U.S. Cl. CPC B01D 33/0376; E21B 21/065; B01D 33/727

(57) ABSTRACT

A system and a method separate fluid and solids of a slurry using a cross-flow shaker (10) as part of a solids removal system. The system has a head pipe (12) to impart head pressure to the slurry. An intake pipe (14) is connected to the head pipe (12) to interface between the head pipe (12) and a cross-flow chamber (18). Separating screens (20A-20D) are set into the cross-flow chamber (18) to allow fluid to separate as the slurry flows tangentially across the surface of the separating screens (20A-20D). The cross-flow chamber (18) is vibrated by vibration motors (30). The flow of slurry through the cross-flow chamber (18) is restricted by an orifice (34) in an end cap (32) creating back pressure. The solids and the remaining fluid exit the cross-flow chamber (18) through the orifice (34) in the end cap (32).

### CROSS-REFERENCE TO RELATED APPLICATIONS

This application claims the benefit of U.S. Provisional Patent Application No. 61/823,619, filed 15 May 2013 (15/05/2013), the disclosure of which is incorporated herein by reference.

### BACKGROUND OF THE DISCLOSURE

Fluids used in industrial applications may accumulate solid particulates and form into a slurry. These fluids maybe oil-based, synthetic-based, and water-based. One example of a fluid circulated in an industrial environment may be a drilling fluid. Drilling fluid, often called “mud,” serves multiple purposes in the Oilfield industry. Drilling mud acts as a lubricant to lubricate rotary drill bits and facilitate faster drilling rates. Furthermore, the drilling mud counterbalances pressure encountered in the subterranean formation. Various weighting and lubrication agents are mixed into the drilling mud to obtain the right mixture for the type and construction of the formation to be drilled. Because the mud evaluation and mixture process may be time consuming and expensive, drillers and service companies prefer to reclaim the returned drilling mud and recycle it for continued use. Another purpose of the drilling mud is to carry the cuttings away from the drill bit to the surface. In the well bore, the cutting solids enter the drilling mud to form the slurry. To save time and expense, companies prefer to reuse the drilling mud instead of replacing it. However, the solids must be removed before the drilling mud maybe reused.

The recirculation of the fluid requires quick and efficient removal of the solids. One type of device used to remove solids is commonly referred to in the industry as a “shale shaker.” A shale shaker, also known as a vibratory separator, is a vibrating sieve-like table upon which the slurry is deposited and through which substantially cleaner fluid emerges. Typically, the shale shaker is an angled table with a generally perforated filter screen bottom. Returning slurry is deposited at the top of the shale shaker. As the slurry travels down the incline toward the lower end, the fluid component falls through the perforations to a reservoir below thereby leaving the solid particulate material behind. The combination of the angle of inclination with the vibrating action of the shale shaker table moves the solid particles left behind until they fall off the lower end of the shaker table.

Screens used with shale shakers are typically placed in a generally horizontal fashion on a generally horizontal bed or support within a basket in the shaker.

The basket in which the screens are mounted may be inclined towards a discharge end of the shale shaker. The shale shaker imparts a rapidly reciprocating motion to the basket and the screens. The slurry is poured onto a back end of the basket and flows toward a discharge end of the basket. Large particles that are unable to move through the screen remain on top of the screen and move toward the discharge end of the basket where they are collected. The fluids flow through the screen and collect in a reservoir beneath the screen. However, the throughput of the shale shaker is reduced by providing vibration at frequencies and motions that optimize the conveyance of the solids from the separating screens to the discharge end.

Additionally, the throughput of slurry processed by a solids control system is traditionally increased by connecting multiple shakers together. However, increasing the number of shakers increases the footprint of the solids control system. Increasing the footprint of the solids control system may be impractical for some applications. Furthermore, connecting multiple shakers increases the cost and complexity of the solids control system.

### BRIEF DESCRIPTION OF THE DRAWINGS

FIG. 1 is a perspective view of an exemplary embodiment of a cross-flow shaker.

FIG. 2 is a perspective view of an exemplary embodiment of a cross-flow shaker without an end cap or an end cap orifice.

FIG. 3 is a side view of an exemplary embodiment of a cross-flow shaker.

FIGS. 4A and 4B are cross-sections of an embodiment of a cross-flow chamber with internal divider screens.

FIG. 5 is a view of an embodiment of the cross-flow shaker with a flow manifold.

FIGS. 6A-6G show cross-sections of embodiments of the cross-flow shaker.

FIGS. 7A and 7B show cross-sections of embodiments of the cross-flow shaker.

FIG. 8 is a diagram showing the flow of slurry through an exemplary embodiment of the cross-flow shaker.

FIG. 9 is a perspective view of another exemplary embodiment of a cross-flow shaker.

### DETAILED DESCRIPTION

The embodiments disclosed herein related to systems and methods for separating solids from oil-based, synthetic-based and water-based fluids. More specifically, embodiments disclosed herein relate to systems and methods for separating solid from fluid using a cross-flow shaker. As used herein, a slurry refers to a mixture of fluid and solids. Cross-flow refers to a direction of flow that may be at least partially across the face of separating screens. Head pressure refers to pressure energy per unit weight of the slurry.

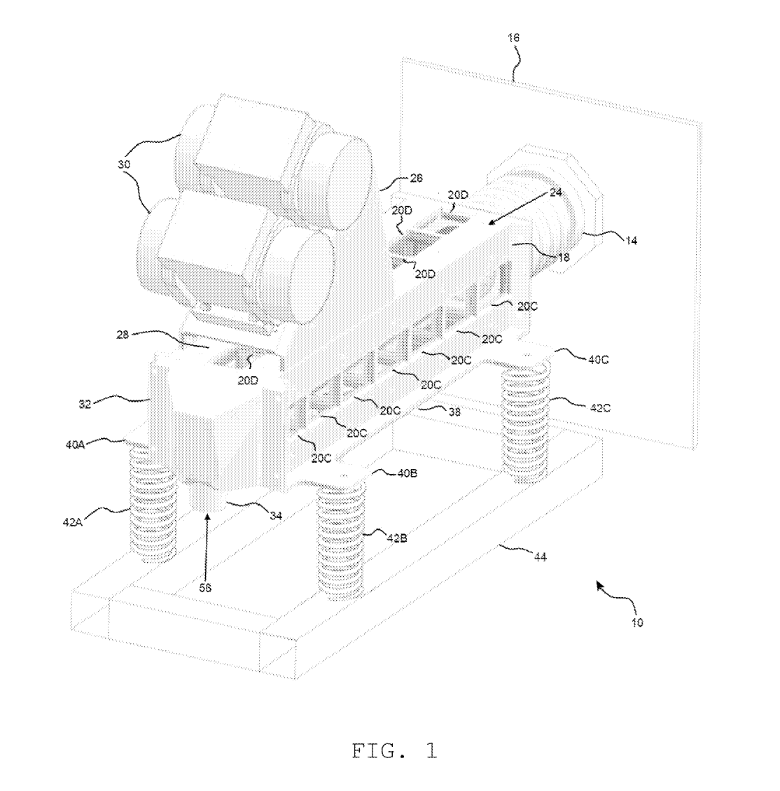

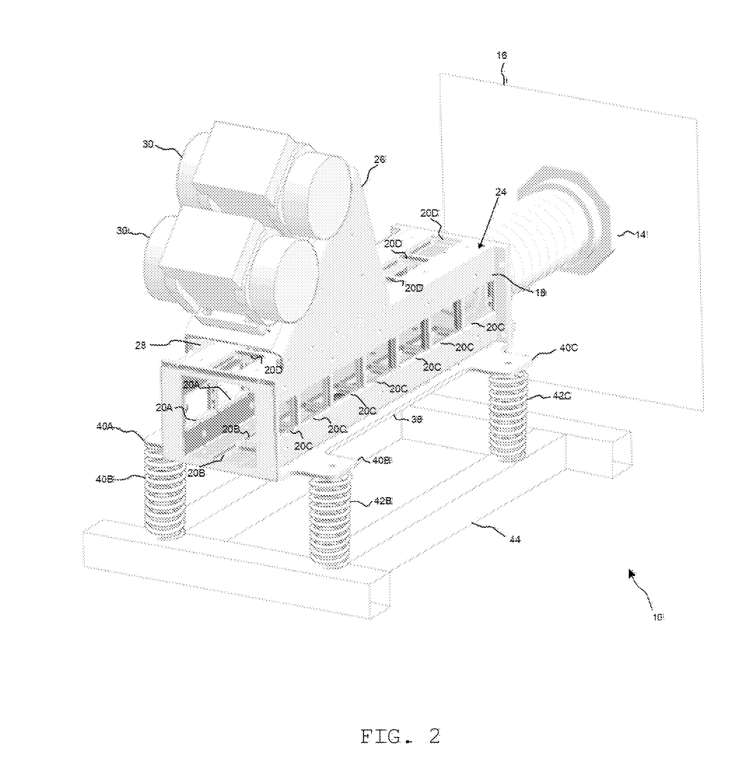

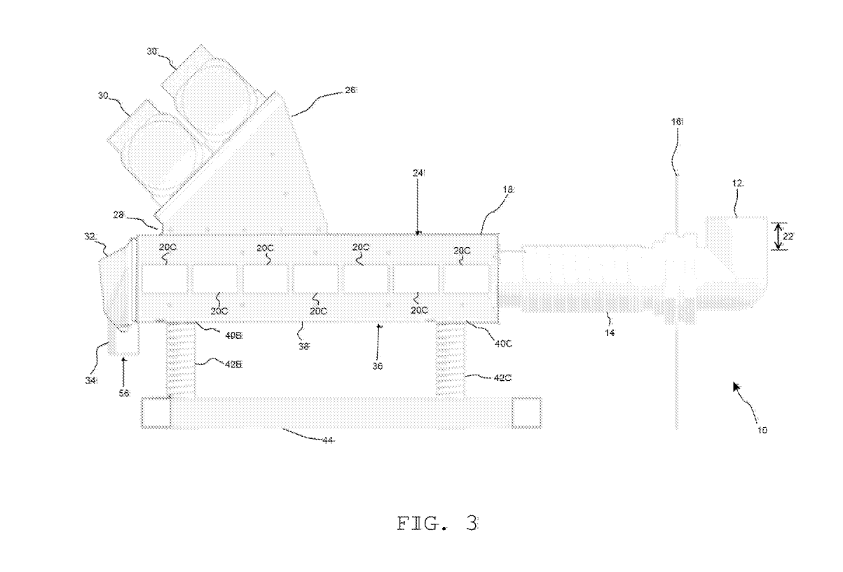

FIG. 1, FIG. 2 and FIG. 3 illustrate an embodiment of a cross-flow shaker 10. In the embodiment, a slurry may be fed into a head pipe 12 at an input rate of flow from a back pressure control system (not shown). The head pipe 12 may be connected to an intake pipe 14 through a barrier wall 16. The slurry flowing into the intake pipe from the head pipe 12 may be pressurized by head pressure provided by the height 22 of the head pipe 12. The slurry may flow from the intake pipe 14 into a cross-flow chamber 18. Screens 20A, 20B, 20C and 20D may be positioned into multiple sides of the cross-flow chamber 18. The screens 20A-20D may have any predetermined mesh size that may be required, such as a predetermined mesh size to separate solids of the slurry from fluids of the slurry. Mesh size used herein refers to the size of the apertures in the screens 20A-20D.

The head pipe 12 may be a pipe with a portion extending vertically to a height 22. Increasing the vertical height 22 of the head pipe 12 may increase the head pressure of the slurry and, as a result, may increase the pressure of the slurry as the slurry enters the intake pipe 14. The increased slurry pressure may result in improved separation of the fluid from the slurry through the screens 20A-20D.

The cross-flow chamber 18 may have a top 24 and a bottom 36. The top 24 of the cross-flow chamber 18 may be connected to a motor support frame 26. A space 28 between the motor support frame 26 and the screen 20B may provide space for the fluid to separate through screen 20B. The fluid that separates from the slurry through the screens 20A-20D may collect in a reservoir, a hopper or a collection pan (not shown) below the cross-flow shaker 10.

As shown in FIG. 1, FIG. 2 and FIG. 3, vibration motors 30 may be attached to the motor support frame 26 to vibrate the cross-flow chamber 18. The vibration provided by the vibration motors 30 to the cross-flow chamber 18 may be configured to separate one phase of the slurry from a second phase of the slurry, such as a liquid phase portion from a solid phase portion. The vibration maybe preselected based on the application, for example, the vibration maybe selected to maximize filtration instead of maximizing solids conveyance. To accomplish maximum filtration, vibration may be optimized for maximum shearing of viscous slurry. As a non-limiting example, the vibration motors 30 may provide vibration at frequencies of 20-40 Hz. The frequencies used to vibrate the cross-flow chamber 18 may be higher or lower based on the viscosity of the slurry or the concentration of solids in the slurry. The intake pipe 14 may be flexible to interface between the head pipe 12 and the cross-flow chamber 18.

As the slurry flows through the cross-flow chamber 18, the fluid phase of the slurry may separate from the solids phase of the slurry through the screens 20A-20D. The arrangement of the cross-flow chamber 18 and/or the vibration applied may substantially prevent solids from accumulating on a portion of the screens 20A-20D. As the slurry moves through the length of the cross-flow chamber 18 and the liquid separates, the slurry may become more concentrated. The concentrated slurry may flow to an end cap 32. The end cap 32 forms a wall on the end of the cross-flow chamber 18 opposite the intake pipe 14. The end cap 32 may have an end cap orifice 34 that may restrict the flow of the concentrated slurry from the cross-flow chamber 18. The restriction in the flow rate may cause back pressure on the slurry. The combination of the head provided by the head pipe 12 and the back pressure from the end cap orifice 34 may cause the liquid in the slurry to pass through the screens 20A-20D. The concentrated slurry may flow through the end cap orifice 34 into an additional stage of a solids control system which may include a drying shaker.

The bottom 36 of the cross-flow chamber 18 may be connected to a chamber support frame 38 that has connection points 40A, 40B and 40C. Resilient mounts 42A, 42B and 42C may be coupled to the connection points 40A, 40B and 40C. The resilient mounts 42A, 42B and 42C may connect the chamber support frame 38 to a base frame 44. The resilient mounts 42A, 42B and 42C may isolate the vibration of the cross-flow chamber 18 from the base frame 44. The resilient mounts 42A, 42B and 42C may be springs. The resilient mounts 42A, 42B and 42C may be any other device known to a person of ordinary skill in the art that may isolate vibration, such as hydraulic dampers and/or pneumatic isolators.

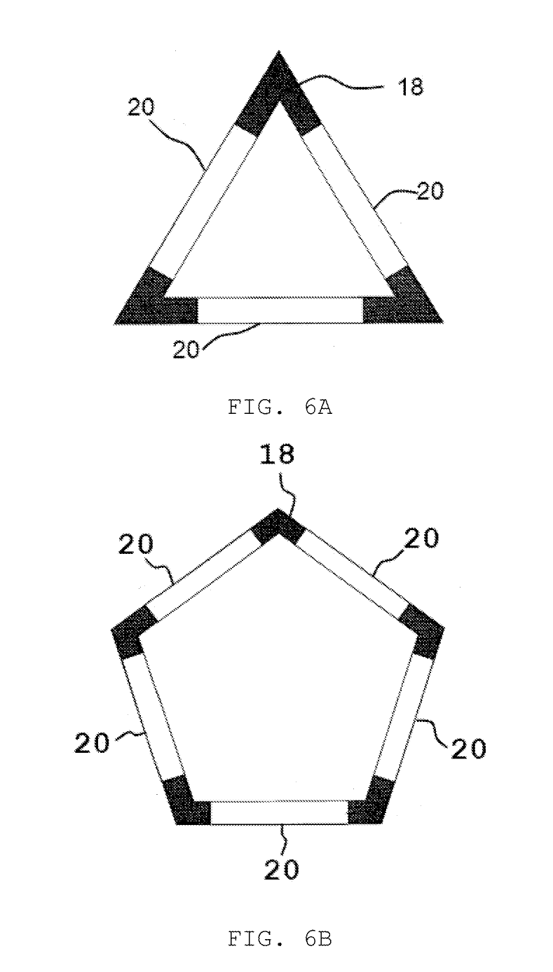

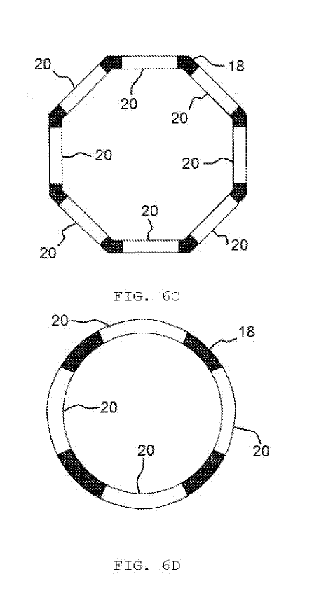

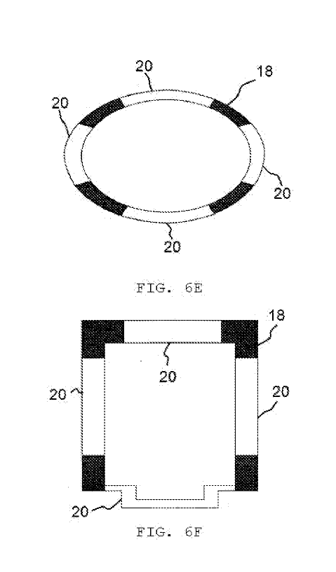

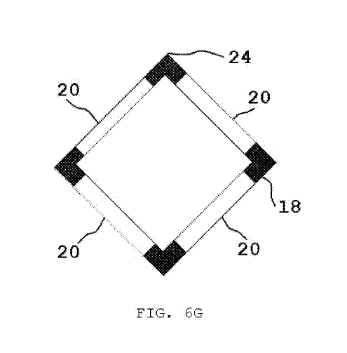

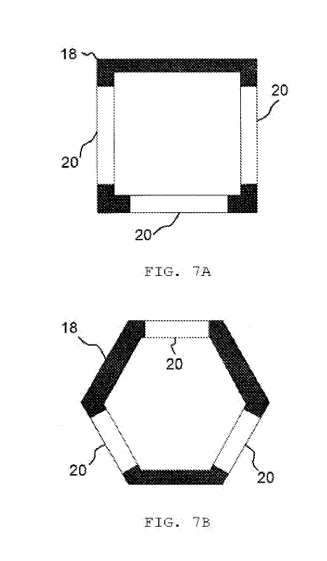

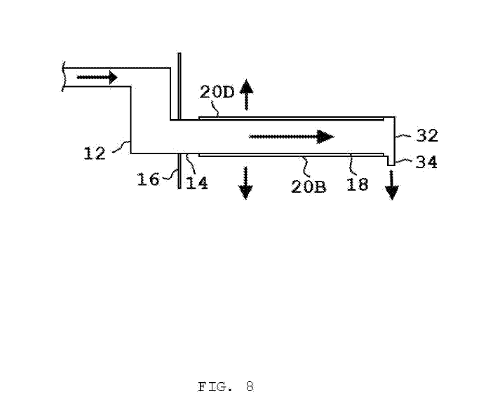

In the embodiment illustrated in FIG. 1, FIG. 2 and FIG. 3, the cross-flow chamber 18 has a square cross-section and the screens 20A-20D are attached to the the cross-flow chamber 18 on four sides. In alternate embodiments, as shown in FIGS. 6A-6C, the cross-flow chamber 18 may have a different polygonal cross-section, for example, a triangle, a pentagon or a hexagon. As shown in FIGS. 6D and 6E, the cross-flow chamber 18 may also have a circular or an elliptical cross-section with curved screens 20 that may be positioned to maximize the separation of the fluid from the slurry. Referring to FIG. 6F, the cross-section of the cross-flow chamber 18 may also be an irregular polygon to accommodate other features, such as a solids drain channel 46. Additionally, the cross-flow chamber 18 may have different orientations with respect to the central axis of the cross-flow chamber 18. As illustrated in FIG. 6G, the cross-section of the cross-flow chamber 18 may be oriented so that the top 24 of the cross-flow chamber 18 may be a corner of the cross-section. The cross-flow chamber 18 may have screens 20 that are located on at least one of the faces of the polygonal cross-section. As shown in FIGS. 7A and 7B, the screens 20 may be located on three sides of the cross-flow chamber 18.

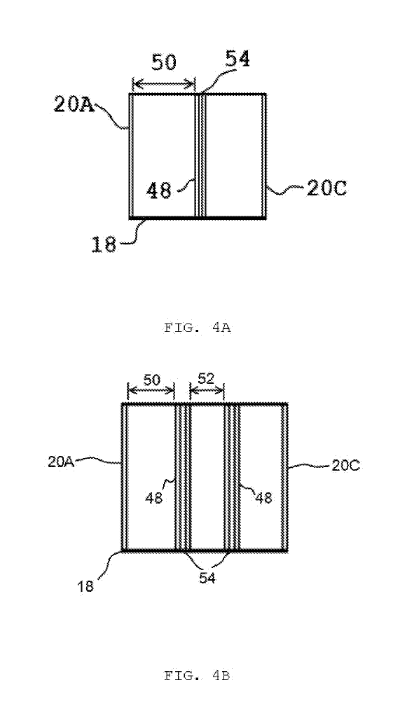

Referring to FIGS. 4A and 4B, in alternate embodiments, the cross-flow chamber 18 may have one or more internal divider screens 48 located on the interior of the cross-flow chamber 18. An outer space 50 may be defined by the region between the internal divider screens 48 and the screens 20. Alternatively, the cross-flow chamber 18 may have more than one internal divider screen 48 defining an interior space 52 between the internal divider screens 48. Slurry may flow in the outer space 50 and the interior space 52 so that slurry passes tangentially across both sides of the internal dividing screens 48. Increasing the number of internal divider screens 48 may increase the amount of fluid that separates from the slurry without substantially increasing the footprint of the cross-flow shaker 10. The internal divider screens 48 may have an inner channel 54 that may allow fluid from the slurry to drain into the inner channel 54.

In the embodiment illustrated in FIG. 1, the cross-flow chamber 18 may be substantially level. In alternate embodiments, the cross-flow chamber 18 may also slope such that vertical plane of the end cap 32 may be below the vertical plane of the intake pipe 14. The decline of the cross-flow chamber 18 combined with the flow of the slurry may allow the solids to move toward the end cap orifice 34. In a further embodiment, the cross-flow chamber 18 may be inclined to promote the separation of fluid from the slurry. The amount of the incline and/or the decline may be selected, as desired. Thus, the cross-flow chamber 18 may be positioned in a range of incline and/or decline from a generally horizontal orientation to a generally vertical orientation.

The end cap orifice 34 may be fixed so that the diameter of end cap orifice 34 remains constant throughout the operation of the cross-flow shaker 10. In another embodiment, the end cap orifice 34 may be adjustable so that the diameter of the end cap orifice 34 may increase or decrease dynamically to compensate for varying flow rates into the cross-flow shaker 10. The adjustable end cap orifice 34 may be mechanically adjusted by a technician at the cross-flow shaker 10. Additionally, the adjustable end cap orifice 34 may be connected to a control system. In this embodiment, the the diameter of the opening 56 of the orifice may be controlled by an analog or digital signal. The control system may include a microprocessor or a proportional-integral-derivative controller. In one embodiment, the end cap orifice 34 may restrict the flow of the slurry from the cross-flow shaker 10. For example, the end cap orifice 34 may restrict the flow of concentrated slurry to 90 percent relative to the rate of flow of the slurry into the cross-flow chamber 18. For example, if the flow rate of the slurry entering the cross-flow chamber 18 is 1200 gallons per minute, the end cap orifice 34 may allow 120-240 gallons per minute of the slurry to flow from the cross-flow chamber 18.

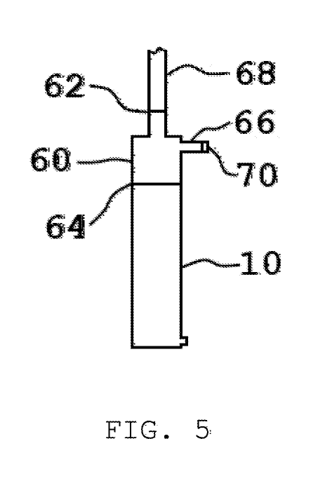

Referring to FIG. 5, a flow manifold 60 may be connected to the cross-flow shaker 10. The flow manifold 60 may have an input 62, an output 64 and a diversion channel 66. The input 62 of the flow manifold 60 may be connected to a conduit 68 that may supply the slurry from a drilling rig or a back pressure control system. The output 64 of the flow manifold 60 may be connected to the head pipe 12 of the cross-flow shaker 10. The diversion channel 66 of the flow manifold 60 may be connected to a diversion orifice 70. After the slurry enters the flow manifold 60, a portion of the slurry may flow into the diversion channel 66 and may exit through the diversion orifice 70 before the remainder of the slurry reaches the head pipe 12. The diverted slurry may be then processed by a drying shaker or other means to separate the fluid from the diverted slurry. The diverted slurry may flow to the same drying shaker as the concentrated slurry exiting the end cap orifice 34. In a further embodiment, the diversion orifice 70 may allow the slurry to flow through the diversion channel 66 at a rate of 200 gallons per minute.

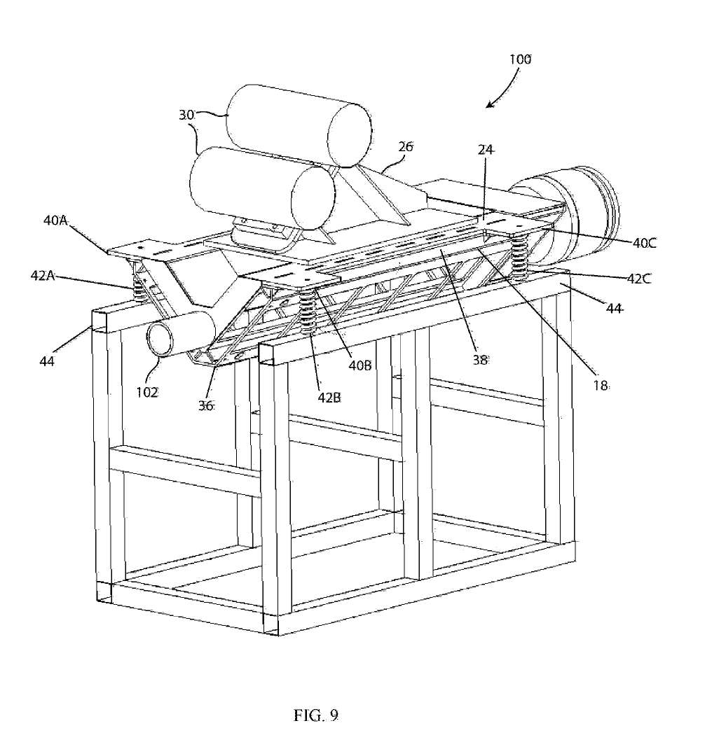

FIG. 8 illustrates separating fluid from the slurry using the cross-flow shaker 10. The slurry may be supplied to the head pipe 12 from a back pressure system. In the head pipe 12, the slurry may gain head pressure. The slurry may flow into the intake pipe 14 and into the cross-flow chamber 18. The slurry may be vibrated at a range of frequencies in the cross-flow chamber 18. Fluid may separate from the slurry as the slurry flows tangentially across the face of the screens 20A-20D and may be collected in a reservoir (not shown). The flow of the slurry may be restricted which may cause back pressure on the slurry.

FIG. 9 illustrates another embodiment of a cross-flow shaker 100 wherein like numerals represent like parts. In the embodiment illustrated in FIG. 9, the cross-flow chamber 18 has a triangular cross-section. The triangular cross-section may occupy a relatively small footprint to save space in congested environments of use.

The top 24 of the cross-flow chamber 18 may be connected to the motor support frame 26. The bottom 36 of the cross-flow chamber 18 may be connected to the chamber support frame 38 that has connection points 40A, 40B and 40C. Resilient mounts 42A, 42B and 42C may be coupled to the connection points 40A, 40B and 40C. The resilient mounts 42A, 42B and 42C may connect the chamber support frame 38 to the base frame 44. The resilient mounts 42A, 42B and 42C may isolate the vibration of the cross-flow chamber 18 from the base frame 44.

As shown in FIG. 9, the vibration motors 30 may be attached to the motor support frame 26 to vibrate the cross-flow chamber 18. The vibration provided by the vibration motors 30 to the cross-flow chamber 18 may be configured to separate one phase of the slurry from a second phase of the slurry, such as a liquid phase portion from a solid phase portion. The solids may exit the cross-flow shaker 100 through a discharge pipe 102.

The embodiments disclosed herein may be used as part of the solids control system of an on-shore or an off-shore drilling operation. The fluid in the slurry may be a drilling mud used in drilling a well bore.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the present disclosure should be limited only by the attached claims.

1. A method comprising:
connecting a head pipe to a cross-flow shaker to impart head pressure to a slurry wherein the cross-flow shaker has screens having a surface arranged in a chamber;
vibrating the chamber;
flowing the slurry tangentially over the surface of the screens to pass liquid in the slurry through the screens and the orifice.

2. The method of claim 1 further comprising:
combining head pressure from the head pipe and back pressure from the orifice to cause liquid in the slurry to pass through the screens.

3. The method of claim 1 further comprising:
restricting the flow of the slurry through the chamber by an orifice located in a wall of the cross-flow chamber to create back pressure.

4. The method of claim 1 further comprising:
maximizing filtration of the slurry by selecting vibration of the chamber to maximize shearing of the slurry.

5. The method of claim 1 further comprising:
selecting vibration of the chamber to maximize solids conveyance.

6. The method of claim 1 further comprising:
interfacing an intake pipe between the head pipe and the chamber.

7. A system comprising:
a cross-flow shaker having a chamber wherein the chamber is vibrated during operation;
a head pipe connected to the cross-flow shaker to impart head pressure to a slurry to the cross-flow shaker;
an intake pipe connected to the head pipe to interface between the head pipe and the chamber;
a screen arranged in the chamber of the cross-flow shaker wherein fluid in the slurry separates as the slurry flows tangentially across the screen; and
an orifice located in the chamber wherein flow of the slurry through the chamber is restricted by the orifice and wherein solids in the slurry exit the chamber through the orifice.

8. The system of claim 7 wherein the chamber has a square cross-section and the screens are attached to the chamber on four sides.

9. The system of claim 7 wherein the chamber has a polygonal cross-section and the screen have a corresponding polygonal shape.

10. The system of claim 7 wherein the chamber has a circular cross-section and the screen is curved.

11. The system of claim 7 wherein the chamber has an elliptical cross-section and the screen is curved.

12. The system of claim 7 further comprising:
a solids drain channel arranged in an irregular polygon cross-section of the chamber.

13. The system of claim 7 further comprising:
an internal divider screen in the chamber wherein the internal divider screen defines a region between the internal divider screen and the screen wherein fluid from the slurry drains into an inner channel formed in the internal divider screen.

14. The system of claim 7 further comprising:
internal divider screens in the chamber wherein the internal divider screens define a first region between the internal divider screens and the screen and further wherein the internal divider screens define a second region between the internal divider screens wherein the slurry flows in the first region and the second region so that the slurry passes tangentially across the internal dividing screens.

15. The system of claim 7 further comprising:
a flow manifold connected to the cross-flow shaker wherein the flow manifold has an input, an output and a diversion channel wherein the input receives the slurry wherein the slurry flows through the diversion channel and further wherein the output is connected to the head pipe.

16. The system of claim 7 wherein the intake pipe is flexible to interface between the head pipe and the chamber.

17. The system of claim 7 wherein the orifice has an adjustable diameter to compensate for varying flow rates into the cross-flow shaker.

18. A method comprising:
arranging a screen having a surface in a chamber of a shaker having a head pipe to receive a slurry wherein the shaker has a discharge end wherein fluid in the slurry separates as the slurry flows tangentially across the surface of the screen to produce a concentrated slurry; and
restricting flow of the slurry through the chamber by using an orifice in the discharge end wherein solids in the concentrated slurry exit the chamber through the orifice in the discharge end.

19. The method of claim 18 further comprising:
combining head pressure provided by the head pipe and back pressure from the orifice to cause liquid in the slurry to pass through the screen.

20. The method of claim 18 further comprising:
arranging internal divider screens within the chamber wherein the internal divider screens define a first volume between the internal divider screens and the screen and further wherein the internal divider screens define a second volume between the internal divider screens wherein the slurry flows in the first volume and the second volume so that the slurry passes tangentially across the internal dividing screens.
